(19) United States
(12) Patent Application Publication
(10) Pub. No.: US 2015/0138097 A1
(43) Pub. Date: May 21, 2015

(54) SYSTEM AND METHOD FOR ENTERING CHARACTERS ON A RADIO TUNER INTERFACE

(71) Applicant: Honda Motor Co., Ltd., Tokyo (JP)

(72) Inventor: Hajime Yamada, Rancho Palos Verdes, CA (US)

(73) Assignee: Honda Motor Co., Ltd., Tokyo (JP)

(21) Appl. No.: 14/086,641

(22) Filed: Nov. 21, 2013

(51) Int. Cl. G06F 3/02; H04B 1/08; G06F 3/041; G06F 3/023

(52) U.S. Cl. CPC G06F 3/0219; G06F 3/0238; H04B 1/082; G06F 3/0416
USPC 345/172

(57) ABSTRACT

A system and method for entering characters that form a radio station channel and tune in a radio station channel on a radio tuner interface includes a touch screen display which displays a radio tuner interface. The radio tuner interface includes a plurality of character keys on a keypad that can be enabled or disabled to allow a user to touch input an available AM, FM, or satellite radio station channel that is in broadcast range of the location in which the vehicle is located.

### BACKGROUND

Vehicle audio systems displays have evolved over the past few decades from systems that incorporated seven segment LED displays to systems that heavily utilize display screens to show graphics that associate with various audio subsystems. However, as the display feature of systems evolved, many manufacturers continued to utilize physical push button inputs and physical knobs to provide a user control over various functions associated with the systems.

More recently, some vehicle manufacturers have been using graphical user interface systems to provide users with added functionality and versatility when controlling functions associated with the systems. Such technology allows many functions of an audio system to be linked with user inputs on a touch screen that control functionality of various audio subsystems and modes.

Many of these user interface systems utilize various types of user interfaces to provide a means of tuning within a radio subsystem. For example, manufacturers have provided various designs for user interface based knobs, buttons, selection arrows, and facets for tuning of radio stations. However, these virtual systems tend to be cumbersome for a user, and especially for a driver to operate while driving a vehicle. Additionally, these user interfaces typically do not provide the user with more enhanced functionality than typical push button inputs.

Some manufacturers have also utilized a touch screen keypad to enable a user to input characters that comprise a radio station channel and tune in a radio frequency. However, such systems have posed a risk of driver diversion from the road due to mistyping of radio station channels. For example, once a user mistypes the characters that form a radio station channel, such systems provide an error or fail to tune in a radio station that forces the user to retype the characters that form a radio channel. Such mistyping and retyping can increase the probability of visual, manual, and cognitive distraction from driving that can compromise the safety of the user and occupants of the vehicle or other vehicles on the road.

### SUMMARY

According to one aspect, a method for entering characters that form a radio station channel and tune in a radio station on a radio tuner user is provided for a vehicle. The method includes operating the radio tuner user interface to select radio stations on a plurality of bands based on user inputs associated with a plurality of enabled and disabled character keys on a user interface keypad. The enabling and disabling the plurality of character keys on the keypad prior to an input of the first character of a radio station channel is based on at least one of the following: the user selection of the band or a plurality of characters that correspond to a first character of radio station channel. The method further includes enabling and disabling the plurality of character keys on the keypad prior to subsequent input of characters that form a radio station channel based on at least one of the following: the user selection of the band, precedent user input of the plurality of enabled character keys, or the plurality of characters that form radio station channels. The method also includes tuning of radio stations based on receiving user input of the plurality of enabled character keys that form radio station channels.

According to a further aspect, a system for entering characters that form a radio station channel and tune in of a radio station on a radio tuner user interface for a vehicle is provided. Specifically, in accordance with this aspect, the system includes a keypad with a plurality of character keys that can be enabled or disabled. The system also includes a character key processing module for determining characters that form radio station channels and a sequence of user inputs on the plurality of character keys on the keypad that form radio station channels in broadcasting range of a location in which a vehicle is located. Additionally, the system includes at least one user interface touch screen display which is operatively connected to the keypad and radio tuner interface for displaying radio station channel characters, and at least one radio tuner which tunes in radio stations on a band. The system further includes a character key enabling and disabling module for enabling or disabling the plurality of character keys on the keypad based on at least one of the following: a user input for selection of a band, user input of the plurality of enabled character keys that form a radio station channel, a plurality of characters that form radio station channels.

According to still another aspect, a computer readable medium comprising instructions that when executed by a processor execute a method for entering characters that form a radio station channel and tune in a radio station on a radio tuner user is provided for a vehicle. The method includes operating the radio tuner user interface to select radio stations on a plurality of bands based on user inputs associated with a plurality of enabled and disabled character keys on a user interface keypad. The enabling and disabling the plurality of character keys on the keypad prior to an input of the first character of a radio station channel is based on at least one of the following: the user selection of the band or a plurality of characters that correspond to a first character of radio station channel. The method further includes enabling and disabling the plurality of character keys on the keypad prior to subsequent input of characters that form a radio station channel based on at least one of the following: the user selection of the band, precedent user input of the plurality of enabled character keys, or the plurality of characters that form radio station channels. The method also includes tuning of radio stations based on receiving user input of the plurality of enabled character keys that form radio station channels.

### BRIEF DESCRIPTION OF THE DRAWINGS

FIG. 1 is a block diagram of a vehicle audio system as an electronic instrument having various interfaces, according to an exemplary embodiment of the disclosure;

FIG. 2 is a block diagram of a radio tuner interface system and some associated components, according to an exemplary embodiment of the disclosure;

FIG. 3A is a schematic view of a keypad and associated character keys that are being enabled and disabled in a first phase of selection, according to an exemplary embodiment of the disclosure;

FIG. 3B is a schematic view of a keypad and associated character keys that are being enabled and disabled in a third phase of selection, according to an exemplary embodiment of the disclosure;

FIG. 3C is a schematic view of a keypad and associated character keys that are being shown as enhanced, according to an exemplary embodiment of the disclosure.

FIG. 4A is a process flow diagram of a method for enabling and disabling character keys on a keypad of the radio tuner interface system, according to an exemplary embodiment of the disclosure;

FIG. 4B is an illustration of a default list of characters that comprise FM radio station channels and can be utilized by the radio tuner interface system, according to an exemplary embodiment of the disclosure;

FIG. 4C is an illustration of a default list of characters that comprise AM radio station channels and can be utilized by the radio tuner interface system, according to an exemplary embodiment of the disclosure;

FIG. 5A is a process flow diagram for a first phase of enabling and disabling character keys on a keypad of the radio tuner interface system that comprises a FM radio station channel, according to an exemplary embodiment of the disclosure;

FIG. 5B is a process flow diagram for a second phase of enabling and disabling character keys on a keypad of the radio tuner interface system that comprises a FM radio station channel, according to an exemplary embodiment of the disclosure;

FIG. 5C is a process flow diagram for a third phase of enabling and disabling character keys on a keypad of the radio tuner interface system that comprises a FM radio station channel, and tuning in a three or four character FM radio station channel, according to an exemplary embodiment of the disclosure;

FIG. 6A is a process flow diagram for a first phase of enabling and disabling character keys on a keypad of the radio tuner interface system for an AM radio station channel;

FIG. 6B is a process flow diagram for a second phase of enabling and disabling character keys on a keypad of the radio tuner interface system for an AM radio station channel; and

FIG. 6C is a process flow diagram for a third phase of enabling and disabling character keys on a keypad of the radio tuner interface system for an AM radio station channel.

### DETAILED DESCRIPTION

The following includes definitions of selected terms employed herein. The definitions include various examples and/or forms of components that fall within the scope of a term and that can be used for implementation. The examples are not intended to be limiting.

A “processor,” as used herein, processes signals and performs general computing and arithmetic functions. Signals processed by the processor can include digital signals, data signals, computer instructions, processor instructions, messages, a bit, a bit stream, or other means that can be received, transmitted and/or detected.

An “interface circuit” as used herein, refers to is a circuit that links one type of device or component such as the processor with another device or component and converts voltages between the processor and a receiving device or component.

A “bus,’ as used herein, refers to an interconnected architecture that is operably connected to transfer data between computer components within a singular or multiple systems. The bus can be a memory bus, a memory controller, a peripheral bus, an external bus, a crossbar switch, and/or a local bus, among others. The bus can also be a vehicle bus that interconnects components inside a vehicle using protocols such as Controller Area network (CAN), Local Interconnect Network (LIN), among others.

A “memory,” as used herein can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

An “operable connection,” as used herein can include a connection by which entities are “operably connected”, is one in which signals, physical communications, and/or logical communications can be sent and/or received. An operable connection can include a physical interface, a data interface and/or an electrical interface.

A “computer communication,” as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. Computer communication can occur using various protocols and technologies as is known in the art. For example, these can include a wireless system (e.g., IEEE 802.11, IEEE 802.15.1 (Bluetooth)), an Ethernet system (e.g., IEEE 802.3), a token ring system (e.g., IEEE 802.5), a near field communication system (NFC) (e.g., ISO 13157), a local area network (LAN), a wide area network (WAN), a point-to-point system, a circuit switching system, a packet switching system, a cellular network system (e.g., CDMA, GSM, LTE, 3G, 4G), a universal serial bus, among others.

A “user interface,” as used herein can include is a program that uses graphical controls which a user can select by various types of mechanisms such as software and hardware based controls, interfaces, or plug and play devices.

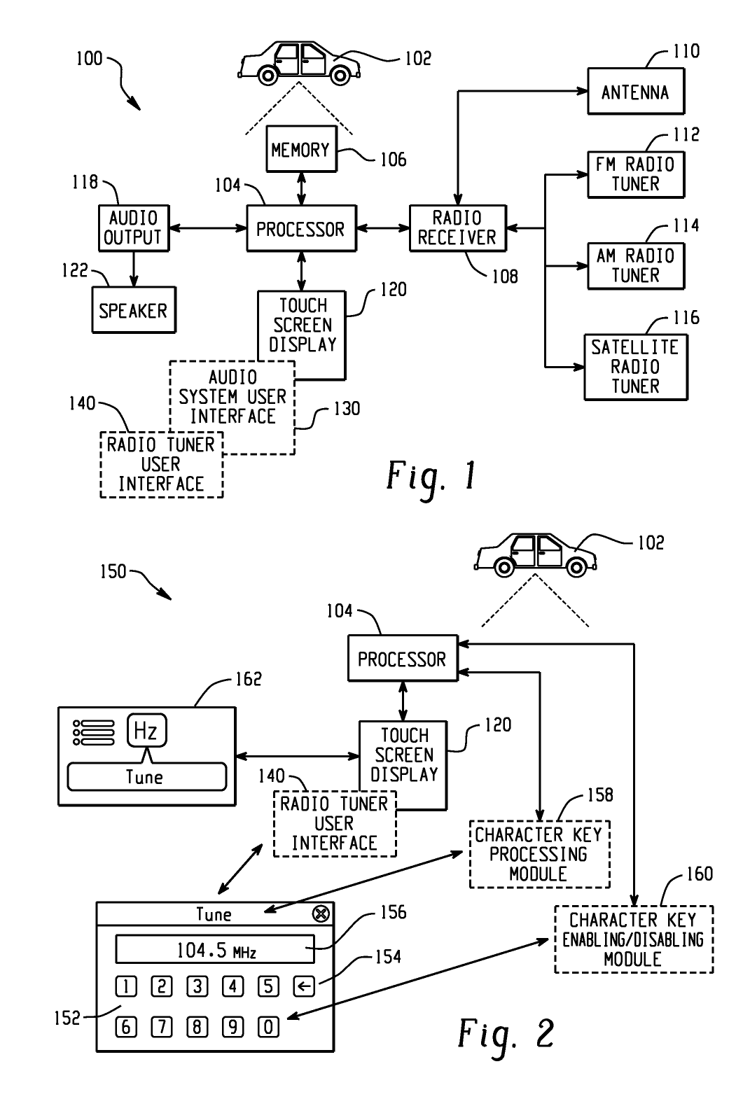

Referring now to the drawings, wherein the showings are for purposes of illustrating one or more exemplary embodiments and not for purposes of limiting the same. FIG. 1 shows an exemplary embodiment for an audio system 100 which may be utilized in a head unit (not shown) of a vehicle 102. The audio system 100 includes a processor 104, memory 106, a radio receiver 108, an antenna 110, a FM radio tuner 112, an AM radio tuner 114, a satellite radio tuner 116, an audio output device 118, one or more speaker(s) 122, a touch screen display 120, an audio system user interface 130, and a radio tuner user interface 140.

It is to be appreciated that the audio system 100 component hardware installed within the head unit of the vehicle can be incorporated with or into other non-audio vehicle subsystems such as vehicle navigation systems, vehicle HVAC systems, or the like, which provide a unified hardware form factor for various components of the audio system 100. For the purposes of simplicity, however the exemplary embodiment will be described with reference to the audio system 100 independent of other vehicle subsystem components.

It is to be appreciated that the audio system 100 may also include a number of additional components and/or interfaces related to various audio modes. However, the exemplary embodiments discussed herein will focus on a radio tuner interface system 150, corresponding system components, and related methods.

In the embodiment shown in FIG. 1, the audio system 100 can be initialized when an accessory (ACC) power of the vehicle 102 is turned on or when a user initializes the audio system 100 by utilizing an ON button or switch. The processor 104 controls an overall operation of the audio system 100 by controlling the audio system user interface 130 that is displayed on the touch screen display 120, which gives a user a means to manipulate a plurality of user inputs that are part of the of the audio system 100. The processor 104 includes internal processing memory, an interface circuit, and bus lines as described in detail above, for transferring data, sending commands, and communicating to various components of the audio system 100.

The processor 104 is also operatively connected to the memory 106. The memory 106 stores programs and data related to the plurality of audio modes that can be initialized from the audio system user interface 130. The processor 104 also controls the plurality of audio modes and related components that can be manipulated by the user through the touch screen display 120. For example, the plurality of audio modes and associated user interfaces could include but are not limited to: a CD player interface system, a MP3 player interface system, a Bluetooth connection player interface system, an auxiliary (AUX) port connection player interface system, and the radio tuner interface system 150. The audio system user interface 130 may also be integrated with non-audio user interface applications associated with other vehicle subsystems. For example, the audio system user interface 130 may be integrated with the vehicle's 102 user interfaced based video infotainment system, a user interface based navigation system, a user interface based HVAC controls system, and/or user interface based lighting controls system.

The processor 104 of the audio system 100 is also operatively connected to the touch screen display 120. Specifically, the touch screen display 120 may comprise of a color LCD display which includes touch screen sensors that provide touch screen functionality. As it is appreciated that systems and methods utilized to provide touch screen functionality are well known to persons skilled in the art, much detail regarding the touch screen system and functionality will not be discussed herein. The touch screen display 120 can be utilized to receive user inputs by sensing a user's touch on the touch screen display 120 and interpreting the touch as a user command. As discussed, the touch screen display 120 can be utilized by the user to interface with the plurality of audio modes that are being executed by the processor 104, such as the radio tuner interface system 150 which will be described in more detail below.

In alternate embodiments, in addition to touch screen display 120, the audio system 100 may include a plurality of user interfaces such as rotating touch switches, push type mechanical switches, an electronic joystick, etc. Each of the touch screen, touch switch, the push type mechanical switches, the joystick, etc. can be used independently or in combination with the touch screen display 120 for a user to utilize different functions while using various audio modes.

The processor 104 is also operatively connected to at least one radio receiver 108 that receives radio frequencies and/or satellite radio signals from one or more antenna(s) 110 that intercept AM/FM radio frequency waves and/or satellite radio signals. The radio receiver 108 converts frequency/signal data from the antenna(s) 110 into usable radio channel data which can be in the form of AM radio station channels, FM radio station channels, and/or satellite radio station channels. In an alternate embodiment, the processor 104 is also operatively connected to a television receiver (not shown) that receives television frequencies and/or satellite television signals from one or more antenna(s) 110 that intercept television frequency waves and or/satellite television signals to be utilized by the vehicle's 102 user interfaced based video infotainment system.

The radio receiver 108 is operatively connected to a plurality of radio tuners 112, 114, 116 which may consist of the FM radio tuner 112, the AM radio tuner 114, and the satellite radio tuner 116. These tuners 112, 114, 116 are utilized by the radio tuner interface system 150 to tune in radio station channels, as described in more detail below. The processor 104 is also operatively connected to an audio output 118 that receives audio data from the radio receiver 108. The audio output 118 feeds the audio data to the speaker(s) 122 to be heard by the user within the vehicle 102.

Upon initialization of the audio system 100, the processor 104 initializes the audio system user interface 130 from memory 106 to appear on the touch screen display 120. The audio system user interface 130 presents the user with a plurality of audio mode icons which correspond to respective audio modes such as described above. The user can utilize the touch screen display 120 to touch input the audio mode icon associated with the audio mode that the user desires to use. Upon sensing the user's touch input on a particular audio mode icon, the processor 104 executes the audio mode system which corresponds to the audio mode icon that the user has selected.

Referring now to FIG. 2, an exemplary radio tuner interface system 150 is shown. The radio tuner interface system 150 includes components similar to those components discussed above with regards to the audio system 100 shown in FIG. 1 and for convenience, like components retain the same numbering. In the illustrated embodiment of FIG. 2, the user has selected the radio tuner interface system 150 by touching and selecting the radio tuner icon 162 on the touch screen display 120. Upon sensing the user's touch of radio tuner mode icon on the touch screen display 120, the processor 104 will retrieve data regarding radio tuner interface system 150 from memory 106 and will initialize the radio tuner interface 140 to be presented to the user on the touch screen display 120.

The radio tuner interface system 150 is controlled by the processor 104 to tune in radio stations that are in broadcast range of the present location of the vehicle 102. The radio tuner interface system 150 utilizes the FM radio tuner 112, the AM radio tuner 114, and the satellite radio tuner 116 to tune in radio station frequency/signals that are being received by the antenna(s) 110. As discussed above, the radio receiver 108 acquires and interprets radio frequency data that is received by one or more the antenna(s) 110. The radio receiver 108 converts the received data into radio channel data which is digitally transmitted with the audio transmission into packets of data that are utilized by various components of the radio tuner interface system 150.

The radio tuner user interface 140 includes a separate display box 156 that can display a plurality of different alpha numeric characters that may represent various radio station related data. In some embodiments, the radio receiver 108 may include a radio data system (RDS) that enables the radio receiver 108 to interpret radio station names or live programming broadcast titles as alphanumeric characters to be displayed on the display box 156 as radio station call letters, radio station names, and/or associated song/program names that are being transmitted by the tuned radio station.

In some embodiments, the radio tuner interface system 150 may include a plurality of FM radio tuners 112, AM radio tuners 114, and/or satellite radio tuners 116 to tune in multiple bands. For example, more then one FM radio tuner 112 may be utilized to tune FM radio stations on a plurality of radio bands such as FM-1, FM-2, FM-3, etc.

The radio tuner interface system 150 includes a character key enabling/disabling module 160 that performs a character key enabling/disabling feature on a user interface based keypad 152 with a plurality of character keys 154 that are displayed as part of the radio tuner user interface 140 on the touch screen display 120. The user may touch the character keys to input a plurality of characters that form characters of AM, FM, or satellite radio station channels by utilizing the touch screen display 120 which provides a touch screen input associated to each character key. The character key enabling/disabling feature is configured to enable some or all of the plurality character keys 154 on the keypad 152 that represent active characters that make up AM, FM, or satellite radio station channels in broadcast range of the location in which the vehicle 102 is located. The character key enabling/disabling feature is also configured to disable some of the plurality of character keys 153 on the keypad 152 that represent non active characters that do not make up AM, FM, or satellite radio station channels in broadcast range of the location in which the vehicle 102 is located.

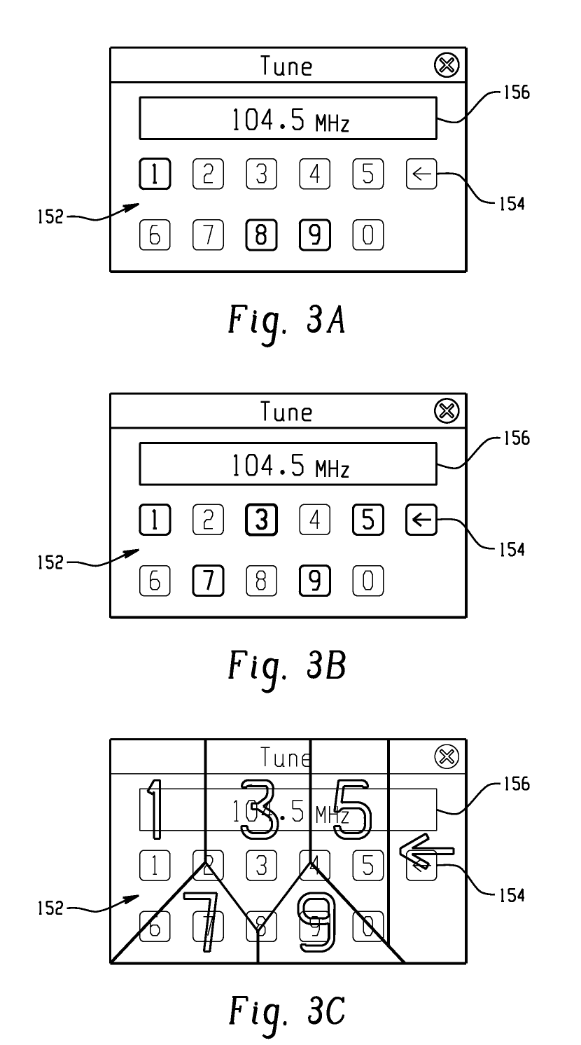

The functionality of the character key enabling/disabling module 160 corresponds to the activation and deactivation of sensors within the touch screen display 120 that are associated with the plurality of character keys 154 on the keypad 152. In the embodiment shown in FIGS. 3A and 3B, enabled keys may be represented as highlighted, indented, bold, enhanced, or the like. Disabled keys may be represented as darkened, depressed, fogged over, reduced, or the like. For example, in the embodiment as shown, if the numeral 4 character key is disabled, the sensor within the touch screen 120 associated with the numeral 4 character key is deactivated. Therefore, the user will not be able to input the numeral 4 character key. The numeral 4 character key may be shown on the touch screen display 120 as darkened or reduced. Similarly, if the numeral 9 character key is enabled, the sensor within the touch screen 120 associated with the numeral 9 character key is activated. Therefore, the user will be able to input the numeral 9 character key. The numeral 9 character key may be shown as highlighted or enlarged.

As shown in FIG. 3C, this functionality of the enabling/disabling module 160 virtually increases the size of the character keys 154 as the user is operating the keypad 152 to input a radio station channel. For example, when the user is utilizing the radio tuner interface system 150 while driving the vehicle 102, the user will be presented with reduced number of character key 154 choices as he or she inputs a radio station channel. This reduction of character key 154 choices virtually increases the size of the character keys 154 that are enabled for the user when driving since the enabled keys are highlighted/enlarged and provide an easily operable display for the driver that reduces the probability of visual, manual, and cognitive distraction from driving.

Although the embodiments discussed herein discuss the plurality of character keys 154 as constituting numeric based characters, in alternate embodiments the plurality of character keys 154 may also be alphanumeric characters, non English characters, symbolic characters, etc. or any combination thereof to be utilized in the radio tuner interface system 150 or other vehicle subsystems. For example, the vehicle 102 video infotainment system may include the character key/enabling disabling module 160, and the plurality of alphanumeric character keys 154 on the keypad 152 to be utilized for tuning in television station channels based on channel numbers, names, or program names.

The radio tuner interface system 150 also includes a character key processing module 158 that is operated by the processor 104. The character key processing module 158 determines the characters that comprise of AM, FM, or satellite radio stations that are in broadcast range of the location of the vehicle 102. Once the character key processing module 158 determines radio station channels that are in broadcast range of the location in which the vehicle 102 in located, the character key processing module 158 classifies those channels as “available radio station channels.” The character key processing module 158 provides data relating to the available radio station channels to the character key enabling/disabling module 160 to initiate the character key enabling/disabling feature to enable or disable the plurality of character keys 154 on the keypad 152 based on the characters that are determined by the character key processing module 158 that comprise the available radio station channels.

In various embodiments, the character key processing module 158 can determine available radio station channels in different manners. In one embodiment, the character key processing module 158 employs the memory 106 to store a list of radio station channels for a plurality of geographical regions associated to populous metropolitan areas, recognized regions, or pre-defined geographical zones. The memory 106 also contains characters that are associated to AM, FM, or satellite radio station channels that are predefined as available radio station channels within certain geographic regions or locations. In alternate embodiments, the radio tuner interface system 150 may contain its own separate internal or external memory that is configured to store data of available radio station channels that are predefined as available radio station channels within certain geographic regions or locations.

The radio tuner interface system 150 can determine the region in which the vehicle 102 is located to properly instruct the character key processing module 158 to query a corresponding list of available radio stations channels that are stored in the memory 106 based on the geographic location in which the vehicle 102 is located. In some embodiments, the user may be asked to input a region or region code if the vehicle 102 is traveling from one region to another. In alternate embodiments, a GPS system (not shown) which may be part of the audio system 100 or a vehicle navigation subsystem can also be utilized to pinpoint the region or location in which the vehicle 102 is located.

In one embodiment, the character key processing module 158 may utilize live scanning to determine radio station channel characters that comprise available radio station channels that are in broadcast range of the location in which the vehicle 102 is located. The radio receiver 108 and tuners 112, 114, 116 can scan and filter radio stations received by the antenna(s) 110 to determine available AM/FM/satellite radio channels in real time as a user is using the radio tuner interface system 150. Specifically, the tuners 112, 114, 116 scan an entire band of frequencies/signals once the user starts to input radio station characters onto the plurality of character keys 154 on the keypad 152. The live scanning may also be utilized to determine a region or location in which the vehicle 102 is traveling. For example, in one embodiment, the live scanner will scan frequencies of radio station channels in broadcast range of the location of the vehicle 102, and a subset of available radio station channels that are scanned and found may be computed into an algorithm and compared back to the radio station list stored in the memory 106 that are tied to a specific region/location.

In some embodiments, the character key processing module 158 can employ both the memory 106 and live scanning that can together determine characters that make up available radio station channels to thereby be used by the character key enabling/disabling module 160. For example, once the live scanning component has scanned frequencies and determined available radio station channels, the data may be stored and categorized into the memory 106 to be accessed by the character key enabling/disabling feature 160 at a later point in time.

In an alternate embodiment, the character key processing module 158 employs an in-vehicle Wi-Fi hotspot (not shown) that is either a separate unit or is a component of another vehicle subsystem that is being operated by the processor 104. The in-vehicle Wi-FI hotspot may include a wireless transmitter and wireless receiver configured to use computer communication through a wireless network. The wireless network can include a cellular phone provider data network, a broadband wireless network, or any other suitable wireless network. The character key processing module 158 may utilize the WI-Fi hotspot to transfer an exchange of information via computer communication to an externally hosted radio station database that resides on one or more external database server(s) at one or more location(s). The radio tuner interface system 150 can query the externally hosted radio station database to obtain the characters that comprise available radio station channels that are predefined as being in broadcast range of a certain geographic region/location.

In some embodiments, the character key processing module 158 can utilize the user's portable smart phone (not shown) that is located within the vehicle 102 to exchange information over the wireless network to the externally hosted radio station database. For example, the character key processing module 158 can utilize the smart phone's wireless tethering capability or an in-vehicle Bluetooth receiver to connect to a wireless data connection provided by the user's smart phone to utilize computer communication for exchanging information with the externally hosted database. The character key processing module 158 can then query the external database to acquire a list of available radio station channels that are in broadcast range of the location in which the smart phone and therefore the vehicle 102 is located.

The character key processing module 158 can utilize additional means to determine which region/location the vehicle 102 is located or traveling in when using a WiFi hotspot which utilizes a cellular data or broadband connection. In some embodiments, when user's smart phone is located within the vehicle 102, the character key processing module 158 is configured to obtain/provide an IP address that may be linked to specific wireless provider's cell site location within a specific region/location. In other embodiments, if a broadband connection is being utilized, the character key processing module 158 is configured to obtain/provide an IP address that may be linked to broadband carrier that is assigned to a specific router or routers at a specific region/location. In other embodiments, the character key processing module 150 can utilize cellular GPS location based services on the user's smartphone located within the vehicle 102 to determine a location of the vehicle 102. Once the location of the vehicle 102 is determined, the character key processing module 158 can utilize the known location of the vehicle 102 to query the externally hosted database for a specific list of available radio station channels that are associated with that particular region/location in which the vehicle 102 is located.

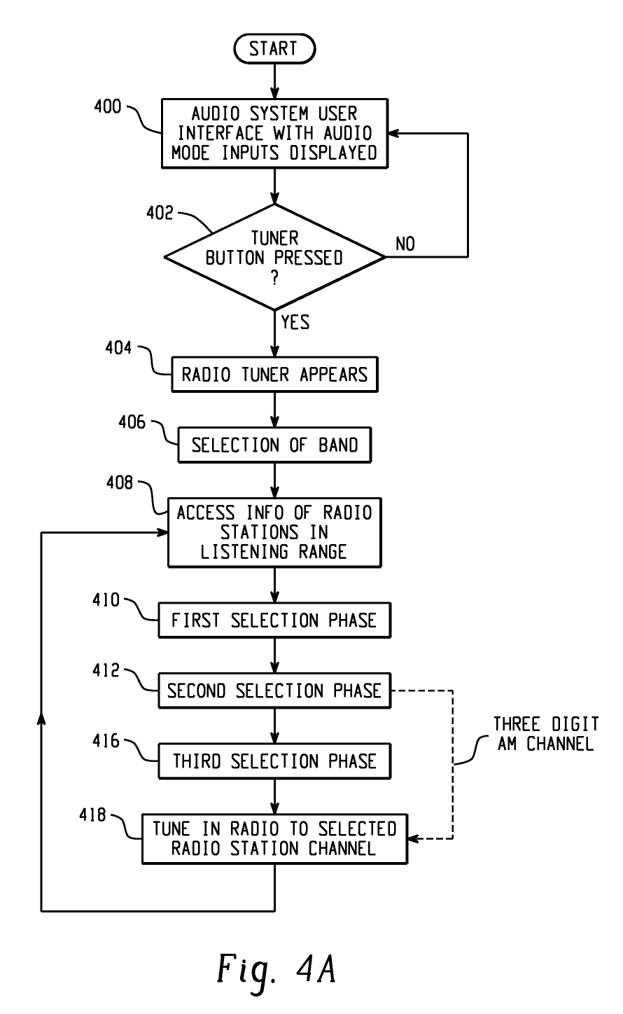

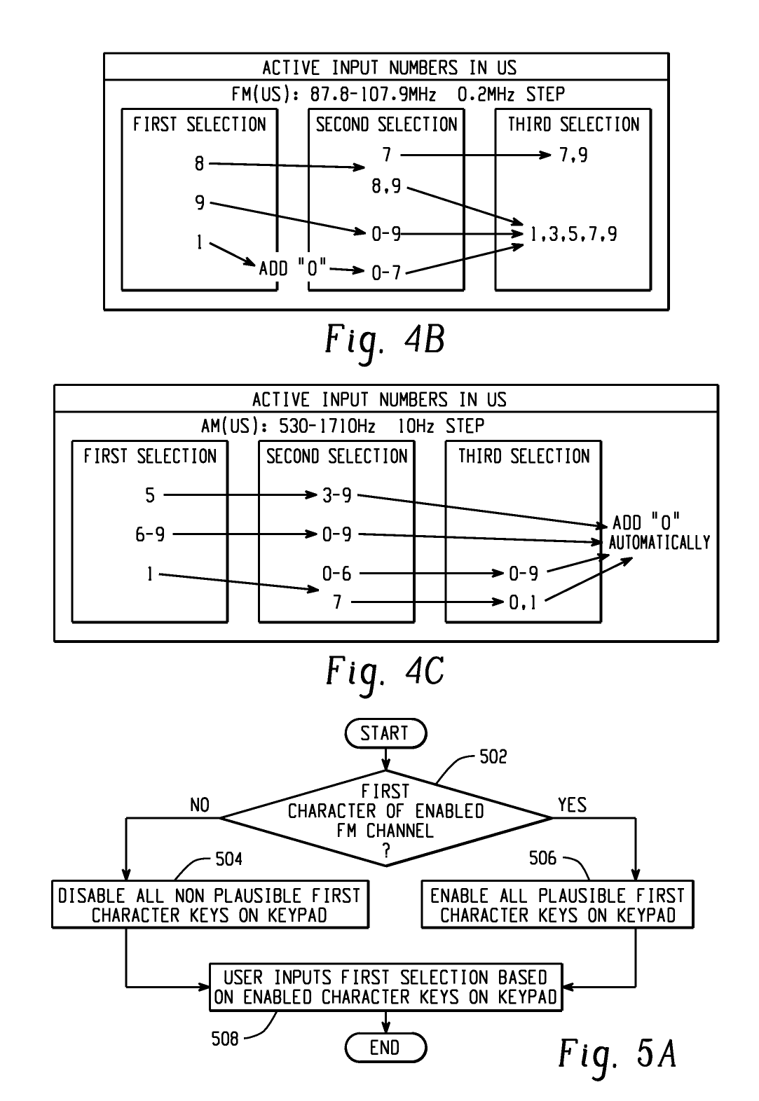

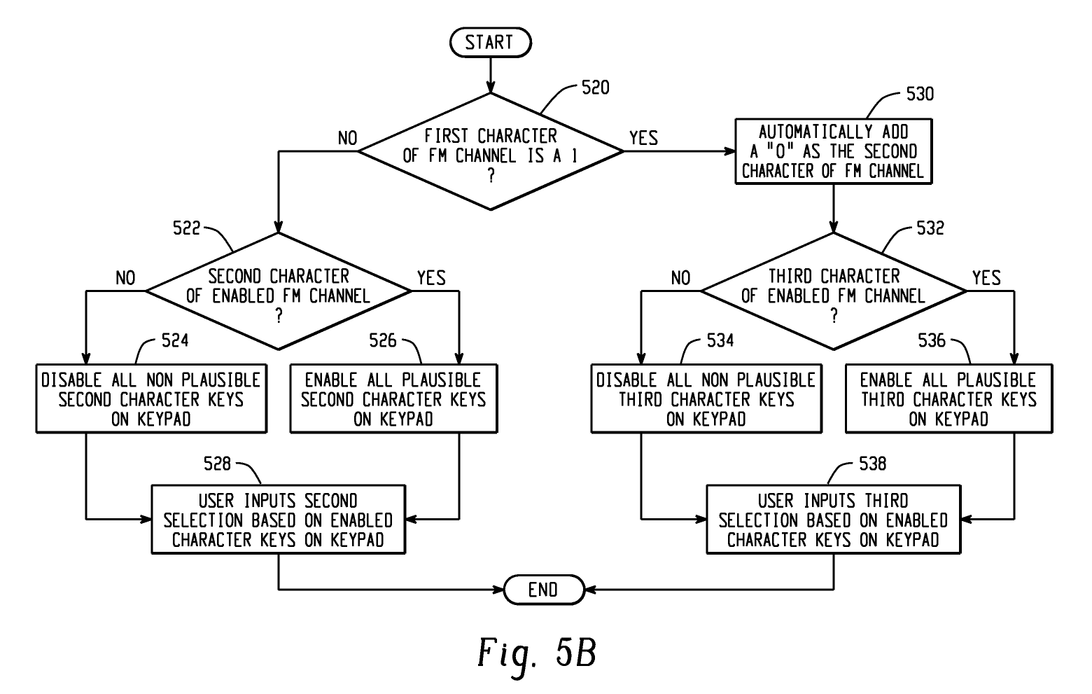

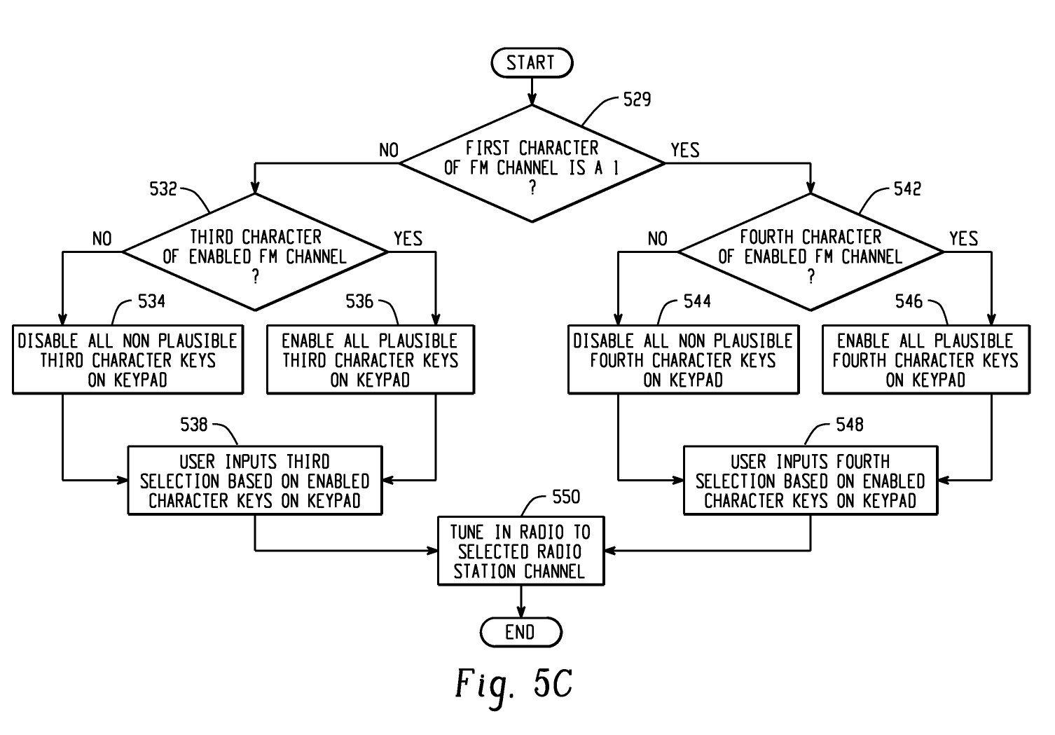

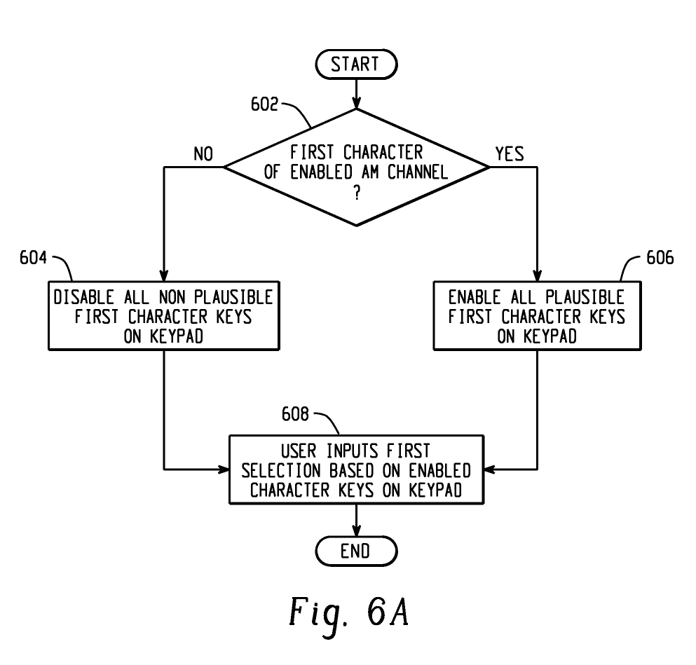

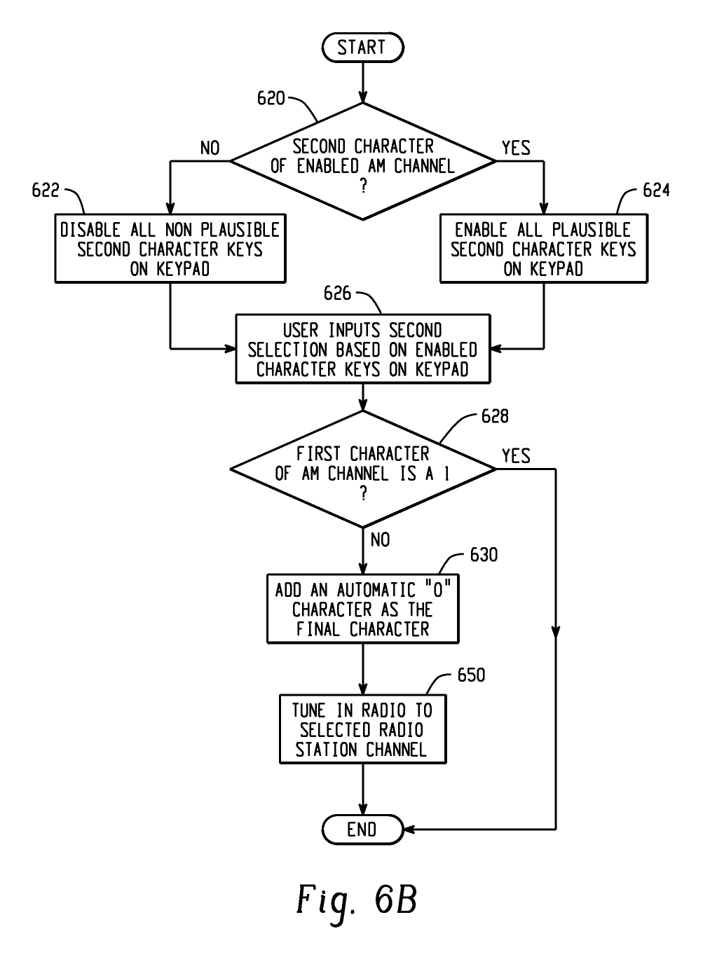

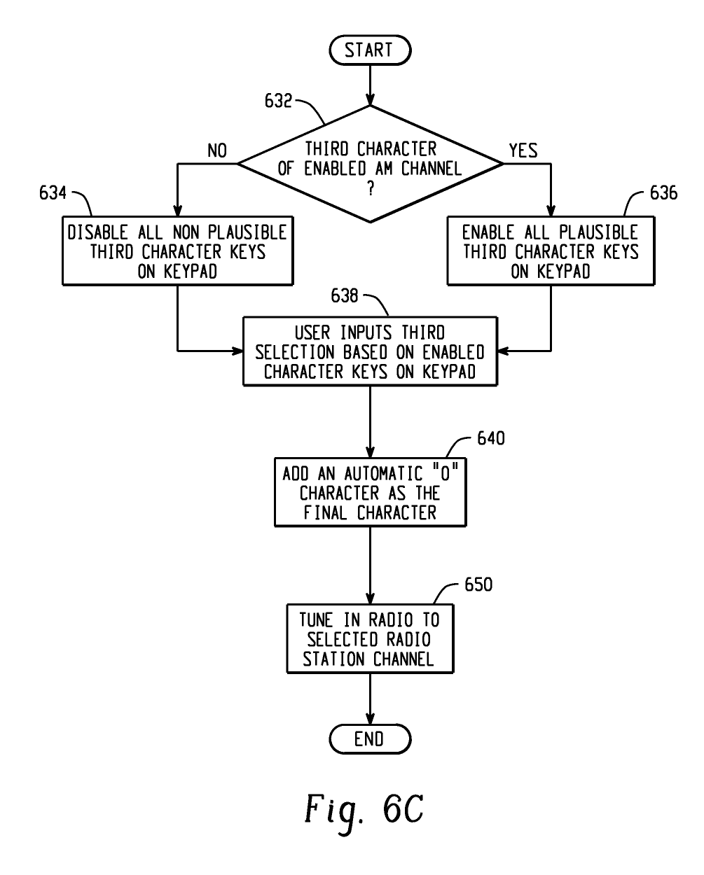

Referring now to FIGS. 4A, 4B, and 4C an exemplary method and accompanying illustrations that may be utilized by several embodiments discussed herein to operate the radio tuner interface system's character key processing module 158 and character key enabling/disabling module 160 in the vehicle 102 are shown. The method of FIG. 4A and accompanying illustrations of FIGS. 4B and 4C will be expanded upon in discussing various embodiments shown in FIGS. 5A, 5B, 5C, 6A, 6B, and 6C, and these methods will be described with reference to the systems and components of FIGS. 1 and 2, though it is to be appreciated that the method could be used with other systems and components.

The method begins at step 400 wherein the user is presented with the audio system 100 on the touch screen display 120. As discussed, the audio system 100 provides the user with a plurality of audio mode icons that correspond to respective audio modes. At step 402, it is determined if the user has inputted the radio tuner icon 162 or a different icon corresponding with a different audio mode. Once the user selects the radio tuner icon 162 at step 404, the radio tuner user interface 140 is presented to the user on the touch screen display 120.

At step 406, the user is given an option to select the AM, FM, or satellite radio band mode which corresponds to the AM radio tuner 112, the FM radio tuner 114, or satellite radio tuner 116 to tune in radio stations on the selected band. In some embodiments, the radio tuner interface system 150 defaults to an AM, FM, or satellite radio band based on the user's last selection during a prior use of the radio tuner interface system 150. For example, if the user listened to the FM band during a prior use of the radio tuner interface system 150, the user will be presented with the FM band upon display of the radio tuner user interface 140.

It is determined at step 406 if the user has previously or currently selected the FM band mode, the AM band mode, or the satellite radio band mode. Subsequently, at step 408, the radio tuner interface system 150 utilizes the character key processing module 158 described above to process information on FM radio stations, AM radio stations, or satellite radio stations in broadcast range of the location in which the vehicle 102 is located.

As discussed above, the character key processing module 158 utilizes various means to determine “available radio station channels” and associated characters that comprise those radio station channels that are in broadcast range of the location in which the vehicle 102 is located. The character key processing module 158 further provides the available radio station channels and associated information, such as characters which comprise those available radio station channels, to the character key enabling/disabling module 160 to enable/disable the plurality of character keys 154 on the keypad 152. For example, in one embodiment, the character key processing module 158 can access the memory 106, as described above, to query a list of available radio station channels that are categorized by a certain region and provide the characters that comprise those available radio station channels to the character key enabling/disabling feature 160. In another embodiment, the character key processing module 158 can employ live scanning, as described above, to live scan an entire range of frequencies/signals to determine and provide available radio station channel information to the character key enabling/disabling module 160 inclusive of characters that comprise the available radio station channels.

In yet another embodiment, the vehicle 102 includes the connection to the in-vehicle Wi-Fi hotspot to provide access to the externally hosted radio station database via computer communications, as described above. The character key processing module 158 may query the externally hosted radio station database to determine a list of available radio station channels that are in broadcast range of the geographic region/location in which the vehicle 102 is located and further provide characters that comprise those available radio station channels to the character key enabling/disabling module 160.

The manner of operation of the character key enabling/disabling feature regarding another exemplary embodiment of the radio tuner interface system 150 will be explained for the FM mode with reference to FIGS. 4A, 4B, 5A, 5B, and 5C. Once the radio tuner interface system 150 receives information from the character key processing module 158 which includes characters that form available FM radio station channels the user is presented with a first selection phase at step 410. The user is given the option to use the keypad 152 to input a first character selection of a FM radio station channel on the plurality of character keys 154 that are enabled. As shown in FIG. 4B within the 1st selection box, in an exemplary embodiment, the radio tuner interface system 150 takes into account a default list of characters 8, 9, and 1 that can be utilized to make a first selection of a U.S. based FM radio station channel numeral.

With reference to the exemplary method shown in FIG. 5A, at step 502, the character key processing module 158 determines characters from the default list of first selection characters that are capable of being utilized as a first character of available FM radio station channels. At steps 504 and 506, the radio interface system 150 performs the character key enabling and disabling feature based on characters of available FM radio stations provided by the character key processing module 158. The character key enabling/disabling module 160 enables some of the plurality of character keys 154 on the keypad 152 based on plausible first characters and disables some of the plurality of character keys 154 on the keypad 152 based on non plausible first characters. For example, in a certain location where the vehicle 102 is traveling, if the character key processing module 158 determines that the available FM radio station channels only start with first characters of 8, 9, and 1, then the character key enabling/disabling module 160 will enable the 8, 9, and 1 character keys and all other character keys will be disabled, as shown in FIG. 3A. The user may input the first character key he or she desires to input as part of the radio station channel he or she desires to tune in based on the enabled plurality of character keys 154 that are displayed on the keypad 152, see step 508. The first character corresponding to the first character key inputted by the user is displayed on the display box 156 of the radio tuner interface 140.

With reference back to FIG. 4A, the user is presented with a second selection phase at step 412 wherein the user is given the option to utilize the keypad 152 to input a second character selection and possibly third character selection of a FM radio station channel. As shown in FIG. 4B, within the 2nd selection box, in an exemplary embodiment, the radio tuner interface system 150 takes into account a default list of characters that are associated to a first character that was selected during the first selection phase. For example, if the character 8 was selected during the first selection phase, the characters 7, 8, and 9 are considered default characters. The exemplary method shown in FIG. 5B, provides more detail as to the second selection phase of step 412 in the FM Band mode and the determination of second characters from the default list of characters (shown in FIG. 4B, 2nd selection box). At step 520, the radio tuner interface system 150 determines if the user has inputted the numeral 1 character key during his or her first selection of the enabled plurality of character keys 154.

If at step 520, the radio tuner system 150 determines that the user has not inputted a numeral 1 key at step 508, the radio tuner interface system 150 determines that the user is attempting to key in a three digit FM radio station since all FM radio station channels that do not start with a numeral 1 comprise of three characters. In alternate embodiments, the radio tuner interface system 150 may determine that the user is inputting a three digit FM radio station channel and performs the character key enabling/disabling feature during the first or the third selection phase.

With reference back to FIG. 5B, at step 522, the character key processing module 158 determines second characters from the default list of second selection characters (shown in FIG. 4B, 2nd selection box) that are capable of being utilized as a second character of available FM radio station channels that includes the first character key value inputted by the user. At steps 524 and 526, the radio interface system 150 performs the character key enabling and disabling feature based on characters provided by the character key processing module 158. The character key enabling/disabling module 160 enables some of the plurality of character keys 154 on the keypad 152 based on plausible second characters and disables some of the plurality of character keys 154 on the keypad 152 based on non plausible second characters.

In an example of a three digit FM channel input, the user inputs the 9 character key as his or her selection of the enabled plurality of character keys 154. In a certain location where the vehicle 102 is located/traveling, if the character key processing module 158 determines that with the first character being 9 only the 2, 4, and 6 characters can be plausible second characters of available FM radio stations, then only the 2, 4, and 6 character keys will be enabled and all other characters will be disabled. The user may input the second character key he or she desires to input as part of the radio station channel he or she desires to tune in based on the enabled keys displayed on the keypad 152, see step 528. The second numeral corresponding to the second character key inputted by the user is displayed on the display box 156 of the radio tuner user interface 140.

With reference back to step 520, if for instance the user had selected the numeral 1 character key at step 508, the radio tuner interface system 150 determines that the user is attempting to key in a four character FM radio station channel since all FM radio station channels that start with a numeral 1 comprise of four characters. In alternate embodiments, the radio tuner interface system 150 may determine that the user is inputting a four character FM radio station channel and performs the character key enabling/disabling feature during the first or the third selection phase. In other embodiments, the radio tuner interface system 150 may make the determination that a user may be inputting a three or four character radio station channel input upon the user's second input selection of the numeral 0, and the character key enabling/disabling module 160 may display plausible third and fourth enabled plurality of character keys 154 during the second or third phase of selection.

With reference back to FIG. 5B, at step 530, the radio tuner interface system 150 automatically adds a second character as a numeral 0 (shown in FIG. 4B, between the 1st and 2nd selection boxes) since all FM radio station channels that start with the numeral 1 also include the numeral 0 as the second character. Subsequently, at step 532, the character key processing module 158 determines third characters from the default list of second selection characters (shown in FIG. 4B, 2nd selection box) that are capable of being utilized to input active FM radio station channels based off of the user's first character key input of numeral 1 inputted in step 508. At steps 534 and 536, the radio interface system 150 performs the character key enabling and disabling feature based on characters of available FM radio stations provided by the character key processing module 158. The character key enabling/disabling module 160 enables some of the plurality of character keys 154 on the keypad 152 based on plausible third characters and disables character keys on the keypad 152 based on non plausible third characters.

In an example of a four digit FM channel input, the user selects the 1 character key as his or her first selection of enabled character keys. In the location where the vehicle 102 is traveling, if the character key processing module 158 determines that with a first character of 1 and an automatic second character of 0, only the 2, 4, 6, and 7 characters can be plausible third characters of available FM radio stations, then only the 2, 4, 6, and 7 character keys will be enabled and all other character keys will be disabled. The user may input the third character key he or she desires to input as part of the radio station channel he or she desires to tune in based on the enabled plurality of character keys 154 displayed on the keypad 152, see step 538. The third numeral corresponding to the third numeric character key inputted by the user is displayed on the display box 156 of the radio tuner user interface 140.

With reference back to FIG. 4A, the user is presented with a third selection phase at step 416 wherein the user is given the option to utilize the keypad 152 to input a third and possibly fourth character(s) selection of a FM radio station channel. As shown in FIG. 4B, within the 3rd selection box, in an exemplary embodiment, the radio tuner interface system 150 takes into account a default list of characters that are associated to first and second characters that were selected during the first and second selection phase. For example, if the character 9 was selected during the first selection phase, and the character 2 was selected during the second selection phase, the characters 1, 3, 5, 7, 9 are considered default characters. The exemplary method shown in FIG. 5C provides more detail as to the third selection phase of step 416 in the FM Band mode. At step 529, the radio tuner interface system 150 determines if the user has inputted a third character at step 538 or a second character at step 528, based on if the user's first selection was of the numeral one character key at step 508.

If at step 529, the radio tuner system 150 determines that the user has not inputted a numeral 1 key at step 508, the radio tuner interface system 150 determines that the user is attempting to key in a three digit FM radio station. At step 532, the character key processing module 158 determines characters from the default list of third selection characters (shown in FIG. 4B, 3rd selection box) that are capable of being utilized to input an available FM radio station channel that include the first and second character key values inputted by the user. At steps 534 and 536, the radio interface system 150 performs the character key enabling and disabling feature based on characters of available FM radio station channels provided by the character key processing module 158. The character key enabling/disabling module 160 enables some of the plurality of character keys 154 on the keypad 152 based on plausible third characters and disables character keys on the keypad 152 based on non plausible third characters.

For instance, in the three digit FM channel example previously provided, the user selects the 9 character key as his or her first selection of enabled character keys, and a 2 character key as his or her second selection of enabled character keys based on the enabled characters provided. In a certain location where the vehicle 102 is traveling, if the character key processing module 158 determines that with the first character being 9, and a second character being 2, only the 1, 3, 5 characters can be plausible third characters of an available FM radio station channel, then only the 1, 3, and 5 character keys will be enabled and all other character keys will be disabled. The user may input the third character key he or she desires to input as part of the radio station channel he or she desires to tune in based on plurality of enabled character keys 154 displayed on the keypad 152, see step 538. The third numeral corresponding to the third numeric character key inputted by the user is displayed along with the first and second numerals on the display box 156 of the radio tuner user interface 140.

The radio tuner interface system 150 determines that the complete channel has been inputted, adds a decimal preceding the final character, and tunes in the FM radio channel frequency per the user's selections by utilizing the FM tuner 112 at step 550 (also shown in step 418). In the three digit FM channel example previously provided, the user has entered 9, 2, and 3 character keys. Therefore, the radio tuner interface system will utilize the FM tuner to tune in the 92.3 FM radio station channel which will also be displayed on the display box 156 and channeled through the audio output 118 to the speaker(s) 122 to be heard by the user within the vehicle 102. With reference back to FIG. 4A, after the selected channel is tuned in, as described above in reference to step 408, the radio tuner interface system 150 utilizes the character key processing module 158 to process information on FM radio stations in broadcast range of the location in which the vehicle 102 is located for the user to further input another radio station channel as desired.

With reference back to step 529, if for instance, the user has selected the numeral 1 character key at step 508, the radio tuner interface system 150 determines that the user is attempting to key in a four digit FM radio station channel. Subsequently, at step 542, the character key processing module determines characters from the default list of third selection characters (shown in FIG. 4B, 3rd selection box) that are capable of being utilized to input available FM radio station channels that include the first and second character key values inputted by the user in steps 508 and 538. At steps 544 and 546, the radio interface system 150 performs the character key enabling and disabling feature based on characters provided by the character key processing module 158. The character key enabling/disabling module 160 enables some of the plurality of character keys 154 on the keypad 152 based on plausible fourth characters and disables some of the plurality of character keys 154 on the keypad 152 based on non plausible fourth characters.

In the four digit radio station channel example previously provided, the user selects the 1 character key as his or her first selection of enabled character keys, and the user selects a 4 character key as his or her third selection. If the character key processing module 158 determines that with the first character being a 1, a second character being a 0, and a third character being a 4, that only the 1, 3, 5, 7, and 9 can be plausible fourth characters of a radio station in broadcast range then the character key enabling/disabling feature 160 will only enable the 1, 3, 5, 7, and 9 character keys and all other character keys will be disabled, as depicted in FIG. 3B.

The user may touch input the fourth character key he or she desires to input as part of the radio station channel he or she desires to tune in based on the enabled plurality of character keys 154 displayed on the keypad 152, see step 548. The fourth numeral corresponding to the fourth numeric character key touch inputted by the user along with the first, second, and third numerals are displayed on the display box 156 of the radio tuner interface 140. In some embodiments, the character key enabling/disabling module 160 will automatically disable all character keys that represent even numbers as a third character of a three character FM radio station channel, and as a fourth character of a four character FM radio station channel, since all FM radio station channels end with an odd numbered character.

The radio tuner interface system 150 determines that the complete channel has been inputted, adds a decimal preceding the final character, and tunes in the radio channel per the user's selections by utilizing the FM radio tuner 112. In the example previously provided, the user has entered 1, 4, and 5 character keys. Therefore, the radio tuner interface system 150 will utilize the FM tuner to tune in the 104.5 FM radio station channel which will be displayed on the display box 156 (as depicted in FIG. 3B) and channeled through the audio output 118 to the speaker(s) 122 to be heard by the user within the vehicle 102. With reference back to FIG. 4A, after the selected channel is tuned in, as described above in reference to step 408, the radio tuner interface system 150 utilizes the character key processing module 158 to process information on FM radio stations in broadcast range of the location in which the vehicle 102 is located for the user to further input another radio station channel as desired.

The manner of operation of the character key enabling/disabling feature regarding another exemplary embodiment of the radio tuner interface system 150 will be explained for the AM mode with reference to FIGS. 4A, 4C, 6A, 6B, and 6C. As shown in FIG. 4C within the 1st selection box, in an exemplary embodiment, the radio tuner interface system 150 takes into account a default list of characters 5, 6-9, and 1 that can be utilized for a first selection of a U.S. based AM radio station channel.

The user is presented with a first selection phase at step 410 wherein, with reference to the exemplary method shown in FIG. 6A, at step 602, the character key processing module 158 determines characters from the default list of first selection characters (shown in FIG. 4C, 1st selection box) that are capable of being utilized as a first character of an available AM radio station channel. At steps 604 and 606, the radio interface system 150 performs the character key enabling and disabling feature based on characters of available AM radio stations provided by the character key processing module 158. The character key enabling/disabling module 160 enables some of the plurality of character keys 154 on the keypad 152 based on plausible first characters and disables some of the plurality of character keys 154 on the keypad 152 based on non plausible first characters.

For example, in a certain location where the vehicle 102 is traveling, if the character key processing module 158 determines that the available AM radio station channels only start with first characters of 9 and 1, then the character key enabling/disabling module 160 will only enable the 9 and 1 character keys and all other character keys will be disabled. The user may input the first character key he or she desires to input as part of the radio station channel he or she desires to tune in based on the enabled plurality of character keys 154 that are displayed on the keypad 152, see step 608. The first character corresponding to the first character key inputted by the user is displayed on the display box 156 of the radio tuner interface 140.

With reference back to FIG. 4A, the user is presented with a second selection phase at step 412 wherein the user is given the option to utilize the keypad 152 to input a second and possibly third character(s) selection of an AM radio station channel. As shown in FIG. 4C, within the 2nd selection box, in an exemplary embodiment, the radio tuner interface system 150 takes into account a default list of characters that are associated to a first character that was selected during the first selection phase. For example, if the character 5 was selected during the first selection phase, the characters 3-9 are considered default characters. The exemplary method shown in FIG. 6B, provides more detail as to the second selection phase of step 412 in the AM Band mode.

At step 620, the character key processing module 158 determines second characters from the default list of second selection characters (shown in FIG. 4C, 2nd selection box) that are capable of being utilized to input available AM radio station channels that include the first character key value which the user inputted in step 608. At steps 622 and 624, the radio interface system 150 performs the character key enabling and disabling feature based on characters provided by the character key processing module 158. The character key enabling/disabling module 160 enables some of the plurality of character keys 154 on the keypad 152 based on plausible second characters and disables some of the plurality of character keys 154 on the keypad 152 based on non plausible second characters. At step 626, the user inputs a second input on the enabled plurality of character keys 154 on the keypad 152.

With reference to step 628, the radio tuner interface system 150 determines if the user inputted the numeral 1 as the first character key selection at step 608. If for instance, the user has not inputted the numeral 1 character key at step 608, the radio tuner interface system determines that the user is attempting to key in a three character AM radio station channel since all AM channels that do not start with numeral 1 comprise of three characters (as shown in FIG. 4C). At step 630, the radio tuner interface system 150 automatically adds a final and third character as a numeral 0, since all AM radio station channels in the U.S. include numeral 0 as a final character, as shown in FIG. 4C. The numbers corresponding to the first and second character keys inputted by the user are displayed along with the automatically added final numeral 0 on the display box 156 of the radio tuner user interface 140.

The radio tuner interface system 150 determines that the complete channel has been inputted and tunes in the radio channel frequency per the user's selections by utilizing the AM radio tuner 114 at step 650 (also shown in step 118). For example, if the user has entered 9 and 3 as first and second character keys, the radio tuner interface system will utilize the AM tuner to tune in the 930 AM radio station channel which will be displayed on the display box 156 and channeled through the audio output 118 to the speaker(s) 122 to be heard by the user within the vehicle 102. With reference back to FIG. 4A, after the selected channel is tuned in, as described above in reference to step 408, the radio tuner interface system 150 utilizes the character key processing module 158 to process information on AM radio stations in broadcast range of the location in which the vehicle 102 is located, for the user to further input another radio station channel as desired.

In alternate embodiments, the radio tuner interface system 150 may determine that the user is inputting a three digit AM radio station channel and performs the character key enabling/disabling feature 160 during the third selection phase. In other embodiments, the radio tuner interface system 150 may make the determination of adding one or multiple zero characters to the end of AM radio station channels based on the user's input during the first phase of selection.

As shown in FIG. 4C, the third selection phase is only utilized when a 1st selection of numeral 1 has occurred to complete the input of a four character available AM radio station channels. Referring back to FIG. 4A, the user is presented with a third selection phase at step 416 wherein the user is given the option to utilize the keypad 152 to input a third character selection of an AM radio station channel. In this embodiment, the user's three character AM radio channel selection would be tuned in at the second selection phase, at step 650.

The exemplary method shown in FIG. 6C, provides more detail as to the third selection phase of step 412 in the AM band mode. At step 632, the character key processing module 158 determines third characters from the default list of third selection characters (shown in FIG. 4C, 3rd selection box) that are capable of being utilized to input available AM radio station channels that includes the first character 1 and the second character key value inputted by the user in steps 608 and 626. At steps 634 and 636, the radio interface system 150 performs the character key enabling and disabling feature based on characters provided by the character key processing module 158. The character key enabling/disabling module 160 enables some of the plurality of character keys 154 on the keypad 152 based on plausible third characters and disables some of the plurality of character keys 154 on the keypad 152 based on non plausible third characters. The user may input the third character key he or she desires to input as part of the radio station channel he or she desires to tune in based on the enabled plurality of character keys 154 displayed on the keypad 152, see step 638.

At step 640, the radio tuner interface system 150 automatically adds a final and fourth character as a numeral 0, since all AM radio station channels include the numeral 0 as the final character (as shown in FIG. 4C). The numbers corresponding to the first, second, and third numeric character keys inputted by the user along with the automatically added final numeral 0 are displayed the display box 156 of the radio tuner interface 140.

The radio tuner interface system 150 determines that the complete channel has been inputted and tunes in the radio channel frequency per the user's selections by utilizing the AM radio tuner 114 at step 650 (also shown in step 418). For example, if the user has entered 1, 2, and 3 enabled character keys, the radio tuner interface system will utilize the AM radio tuner 114 to tune in the 1230 AM radio station channel which is displayed on the display box 156 and channeled through the audio output 118 to the speaker(s) 122 to be heard by the user within the vehicle 102. With reference back to FIG. 4A, after the selected channel is tuned in, as described above in reference to step 408, the radio tuner interface system 150 utilizes the character key processing module 158 to process information on AM radio stations in broadcast range of the location in which the vehicle 102 is located, for the user to further input another radio station channel as desired.

As discussed, various embodiments of the radio tuner interface system 150 may be utilized for the user to tune in satellite radio station channels. Satellite radio channels in North America that comprise of two numerical characters consist of first characters of 1 through 9, and satellite radio channels that comprise of three numerical characters only consist of first characters of 1 or 2. In some embodiments methods associated to tuning of satellite channels may comprise of two or three input selection phases depending on the first character inputted by the user similar to the AM and FM tuning methods described above.

Furthermore, in some embodiments, the radio tuner interface system 150 character key enabling disabling feature may also be based on a variety of different factors such as the user's satellite radio contract terms and conditions, AM/FM/Satellite radio genre selections based on the user's listening preferences, and/or AM/FM/Satellite radio pre-selected channel favorites. For example, if the user has selected talk radio channels as a genre, the character key enabling disabling feature 160 may only enable or disable some of the plurality of character keys 154 based on a pre-defined subset of radio channels classified as talk radio channels in a certain band or in a plurality of bands.

Furthermore, in some embodiments, the radio tuner interface system 150 character key enabling disabling feature may not be specific to any radio band, and may enable and disable character keys based off of any plausible AM, FM, or satellite radio station channels that are determined by the character key processing module 158 to be in broadcast range of the location of the vehicle 102.

It will be understood by one of ordinary skill in the art that the systems and methods described herein may be adapted and modified as appropriate for the application being addressed or may be employed in other suitable applications, and that such adaptions and modifications are for purposes of illustrating one or more exemplary embodiments and not for purposes of limiting same. It will also be appreciated that various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for entering characters that form a radio station channel and tune in a radio station on a radio tuner user interface for a vehicle, comprising:
operating the radio tuner user interface to select radio stations on a plurality of bands based on user inputs associated with a plurality of enabled and disabled character keys on a user interface keypad;
enabling and disabling the plurality of character keys on the keypad prior to an input of the first character of a radio station channel based on at least one of the following: the user selection of the band or a plurality of characters that correspond to a first character of radio station channels;
enabling and disabling the plurality of character keys on the keypad prior to subsequent input of characters that form a radio station channel based on at least one of the following: the user selection of the band, precedent user input of the plurality of enabled character keys, or the plurality of characters that form radio station channels; and
tuning of radio stations based on receiving user input of the plurality of enabled character keys that form radio station channels.

2. The method of claim 1, further including controlling the enabling and disabling of the plurality of character keys on the keypad as a user inputs characters that form radio channels based on at least one of the following: locally stored data of characters associated to characters that form available radio station channels that are in broadcast range of the location in which the vehicle is located, externally stored data of characters associated to characters that form available radio station channels that are in broadcast range of the location in which the vehicle is located, or live scanning data of characters associated to characters that form radio station channels that are in broadcast range of the location in which the vehicle is located.

3. The method of claim 2, wherein the enabling and disabling of the plurality of character keys on the keypad that forms a first character of a radio station channel is based on at least one of the following: the user selection of the band or the plurality of characters that forms a first active character of radio station channels that are in broadcast range of the location in which the vehicle is located.

4. The method of claim 3, wherein the enabling and disabling of the plurality of character keys on the keypad that form a second character of a radio station channel is based on at least one of the following: a user's first input of the plurality of enabled character keys or a plurality of second characters of radio station channels that are in broadcast range of the location in which the vehicle is located.

5. The method of claim 4, wherein the enabling and disabling of the plurality of character keys on the keypad that form a third character of a radio station is based on the following: the user's selection of the FM band, the user's first input of the plurality of enabled character keys is a numeral one character key, or a plurality of third characters of radio station channels that are in broadcast range of the location in which the vehicle is located.

6. The method of claim 5, wherein a zero is automatically added as a third and last character of an AM radio station channel based on one the following: the user's selection of the AM band mode, the user's first input of the plurality of enabled keys is not a numeral one, or a corresponding AM radio station channel that is in broadcast range of the location in which the vehicle is located that contains a fourth and final character values of zero.

7. The method of claim 5, wherein the enabling and disabling of the plurality of character keys on the keypad that form a third character and final character of a radio station channel is based on at least one of the following: the user's first input of the plurality of enabled character keys, the user's second input of the plurality of enabled character keys, or the plurality of third characters of FM radio station channels that are in broadcast range of the location in which the vehicle is located.

8. The method of claim 7, wherein the enabling and disabling of the plurality of character keys on the keypad that form a fourth character of a FM radio station is based on the following: the user's selection of the FM band mode, the user's first input of the plurality of enabled character keys is a one character key, the user's third input of the plurality of enabled keys, the channel being inputted is a four character channel, or a plurality of fourth characters of FM radio station channels that are in broadcast range of the location in which the vehicle is located.

9. The method of claim 7, wherein a zero is automatically added as a fourth last character of an AM radio station channel based on one the following: the user's selection of the AM band mode, the user's first input of the plurality of enabled keys, the user's second input of the plurality of enabled keys, the user's third input of the plurality of enabled keys, or a corresponding AM radio station channel that is in broadcast range of the location in which the vehicle is located that contains a fourth and final character values of zero.

10. A system for entering characters that form a radio station channel and tune in of a radio station on a radio tuner user interface for a vehicle, comprising:
a keypad with a plurality of character keys that can be enabled or disabled;
a character key processing module for determining characters that form radio station channels and a sequence of user inputs on the plurality of character keys on the keypad that form radio station channels in broadcasting range of a location in which a vehicle is located;
at least one user interface touch screen display which is operatively connected to the keypad and radio tuner interface for displaying radio station channel characters;
at least one radio tuner which tunes in radio stations on a band; and
a character key enabling and disabling module for enabling or disabling the plurality of character keys on the keypad based on at least one of the following: a user input for selection of a band, user input of the plurality of enabled character keys that form a radio station channel, a plurality of characters that form radio station channels.

11. The system of claim 11, wherein the character key enabling and disabling module conducts a character key enabling/disabling feature which enables a plurality of character keys on the keypad and activates the functionality of the enabled plurality of character keys on the keypad, and disables a plurality of character keys on the keypad and deactivates the functionality of disabled plurality of character keys on the keypad.

12. The system of claim 11, wherein the character key processing module provides data to the character key enabling and disabling feature based on at least one of the following: the user input on the band input selection button for selection of the band, a plurality of channels of radio stations that are contained in internal memory and form a plurality of channels of radio stations that are in broadcast range of the location in which the vehicle is located, a plurality of channels of radio stations that are contained in external memory and form a plurality of channels of radio stations that are in broadcast range of the location in which the vehicle is located, a plurality of channels of radio stations that are contained in an external database, or a plurality of channels of radio stations that are found a live scanning component and form a plurality of channels of radio stations that are in broadcast range of the location in which the vehicle is located.

13. The system of claim 11, wherein the character key enabling and disabling module conducts the character key enabling and disabling feature based on at least the following: the user input on the band input selection button for selection of band or a plurality of characters that form a first active character of radio station channels that are in broadcast range of the location in which the vehicle is located.

14. The system of claim 12, wherein the character key enabling and disabling module conducts the character key enabling and disabling feature based on the following: the user's first input of the plurality of enabled character keys on the keypad or a plurality of second characters of radio station channels that are in broadcast range of the location in which the vehicle is located.

15. The system of claim 13, wherein the character key enabling and disabling module conducts the character key enabling and disabling feature based on at least one of the following: the user's first input of the plurality of enabled character keys on the keypad, a user's second input of the plurality of enabled character keys on the keypad, or the plurality of third characters of radio station channels that are in broadcast range of the location in which the vehicle is located.

16. The system of claim 14, wherein the character key enabling and disabling module conducts the character key enabling and disabling feature based on at least one of the following: the user's selection of the FM band mode, the user's first input of the plurality of enabled character keys is a numeral one character key, the user's third input of the plurality of enabled keys, the channel being inputted is a four character channel, or a plurality of fourth characters of FM radio station channels that are in broadcast range of the location in which the vehicle is located.

17. The system of claim 15, wherein the radio tuner interface system adds a last character or characters of an AM radio station channel based on one the following: the user's selection of the AM band mode, the user's second input of the plurality of enabled keys, the user's third input of the plurality of enabled keys, a corresponding AM radio station channel that is in broadcast range of the location in which the vehicle is located that contains a third and final character value of zero, or a corresponding AM radio station channel that is in broadcast range of the location in which the vehicle is located that contains fourth and final character value of zero.

18. A computer readable medium comprising instructions that when executed by a processor perform actions comprising:
operating the radio tuner user interface to select radio stations on a plurality of bands based on user inputs associated with a plurality of enabled and disabled character keys on a user interface keypad;
enabling and disabling the plurality of character keys on the keypad prior to an input of the first character of a radio station channel based on at least one of the following: the user selection of the band or a plurality of characters that correspond to a first character of radio station channels;
enabling and disabling the plurality of character keys on the keypad prior to subsequent input of characters that form a radio station channel based on at least one of the following: the user selection of the band, precedent user input of the plurality of enabled character keys, or the plurality of characters that form radio station channels; and
tuning of radio stations based on receiving user input of the plurality of enabled character keys that form radio station channels.

19. A computer readable medium of claim 18, wherein a user input corresponding to a radio tuner initializes a radio tuner interface system and corresponding radio tuner user interface for inputting characters that form a radio station channel on the plurality of character keys on the keypad and tuning in the user inputted radio station channel based on the characters entered.

20. A computer readable medium of claim 18, wherein enabling and disabling of the plurality of character keys on the keypad as a user inputs characters that form radio station channels based at least one of: internally stored data of characters associated to characters that form active radio station channels that are in broadcast range of the location in which the vehicle is located, externally stored data of characters associated to characters that form active radio station channels that are in broadcast range of the location in which the vehicle is located, or live scanning data of characters associated to characters that form active AM or FM channels of radio stations that are in broadcast range of the location in which the vehicle is located.
